(19) United States
(12) Patent Application Publication
(10) Pub. No.: US 2020/0065851 A1
(43) Pub. Date: Feb. 27, 2020

(54) COMPUTER-IMPLEMENTED SYSTEM, METHOD & COMPUTER PROGRAM PRODUCT

(71) Applicant: Q-MATIC AB, Mölndal (SE)

(72) Inventors: Sven-Olof HUSMARK, Mölnlycke (SE); Martin HALLBERG, Göteborg (SE); Mattias BOGEBLAD, Göteborg (SE)

(21) Appl. No.: 16/487,635

(22) PCT Filed: Feb. 9, 2018
(86) PCT No.: PCT/SE2018/050122

§ 371 Date: Aug. 21, 2019

(30) Foreign Application Priority Data
Feb. 22, 2017 (SE) 1750190-9

(51) Int. Cl. G06Q 30/02

(52) U.S. Cl. CPC G06Q 30/0242; G06Q 30/0201; G06Q 30/0269; G06Q 30/0277; G06Q 30/0255

(57) ABSTRACT

Computer-implemented system configured to enable data concerning a person's online behaviour to be combined with data concerning at least one action performed by said person at a physical establishment. The system comprises: a data acquiring entity configured to obtain a unique web analytics identifier from an electronic device of said person, a transaction data collection entity configured to receive data concerning at least one action performed by said person at said physical establishment, and a data integration entity configured to combine said person's unique web analytics identifier with said data concerning at least one action performed by said person at said physical establishment, said combining being independent of location data from said electronic device of said person.

### TECHNICAL FIELD

The present invention concerns a computer-implemented system to enable data concerning a person's online behaviour to be combined with data concerning at least one action performed by that person at a physical establishment, i.e. any building or material structure providing one or more goods and/or services, such as a bank, shop, showroom, post office, restaurant or medical organization. The present invention also concerns a method performed by such a computer-implemented system and a computer program product containing computer program code means arranged to cause a computer or a processor to execute the steps of such a method.

### BACKGROUND OF THE INVENTION

Web analytics is concerned with the measurement, collection, analysis and reporting of web data for the purpose of understanding and optimizing web usage (i.e. the proportion, often expressed as a percentage, of visitors to one or more web sites that use a particular web browser, such as Chrome, Internet Explorer, Firefox etc, or the user flow on a website, i.e. the path a user follows through a website interface to complete a task such as purchasing a product). Web analytics can be used as a tool for business and market research, and to assess and improve the effectiveness of a website or online advertisement.

Google Analytics is currently the most widely used web analytics service on the Internet. When integrated with a service such as Google AdWords, Google Analytics can allow analysts to review online campaigns by tracking landing page quality and conversions (i.e. the act of converting website visitors into paying customers or converting website visitors into some result other than an on-line sale). Every visitor to a particular website monitored by Google Analytics is namely given a globally unique tracking parameter (known as a “GCLID”) which is used by Google to pass information back and forth between Google AdWords and Google Analytics.

Google AdWords has a “store visit conversions”-function whereby a user's phone location history is analyzed to determine whether a website visitor actually visited a physical establishment associated with a particular advertisement and/or website. In order to acquire this information a user must have enabled the location history on his/her smartphone, whereby a user's GPS coordinates are used to determine whether the user was in the proximity of a particular physical establishment whose geographical location must also be known to the web analytics company. Google analytics must therefore be provided with information concerning a person's location and information concerning target geographical locations associated with a particular AdWord in order to determine whether a person that clicked on an AdWord was subsequently in a location in the proximity of a physical establishment associated with that AdWord.

US patent application no. US 2016/0048869 discloses a system and method for attributing in-store visits to exposure to an on-line advertisement campaign. The system gathers advertisement impression data, which generally includes a unique identifier to identify a device, a sub-placement identifier to determine what the advertisement impression was about, and a timestamp of the advertisement impression to indicate the time at which a user got the advertisement impression. The system uses that data to identify users who were exposed to advertisement impressions. The system then uses location data, such as GPS coordinates, activity information (i.e. information concerning user identification, date, number of locations) and in some instances beacon data points reported by mobile devices of the advertisement impression users, to determine if the advertisement impression users visited a target place during a conversion window. Based on the advertisement impression users who were exposed to the advertisement impressions, the system establishes a control group of users who were not exposed to the advertisement impressions to perform quasi-experimental analyses to assess whether the advertisement impressions had any impact on changing the advertisement impression users' physical in-store visitation behavior.

It should be noted that a person that is located in the proximity of a physical establishment associated with an online advertisement cannot automatically be regarded an intentional visit to that physical establishment. Furthermore, such location-history-based store visit conversion tracking does not provide any information as to whether any of people located in the vicinity of a physical establishment associated with an online advertisement actually made a purchase at the physical establishment. Additionally, such location-history-based store visit conversion tracking is not possible if a person switches off, pauses or deletes his/her location history. Even if a person's location history is available to a web analytics company, a lot of location data may have to be collected and analyzed in order to determine whether a person that interacted with an online advertisement actually went to a location in the vicinity of a physical establishment associated with that online advertisement, since that person may visit a physical establishment several days, weeks or months after interacting with an online advertisement.

### SUMMARY OF THE INVENTION

An object of the invention is to provide an improved computer-implemented system that is configured to enable data concerning a person's online behaviour to be combined with data concerning at least one action performed by the person at a physical establishment, i.e. any building or material structure providing one or more goods and/or services, such as a bank, shop, showroom, post office, restaurant or medical organization.

This aim is achieved by a computer-implemented system comprising a data acquiring entity configured to obtain a unique web analytics identifier from an electronic device of the person, a transaction data collection entity configured to receive data concerning at least one action performed by the person at the physical establishment, and a data integration entity configured to combine the person's unique web analytics identifier with the data concerning at least one action performed by the person at the physical establishment, the data combining being independent of location data, from the electronic device of the person. The system is not configured to collect location data from the electronic device of the person, a person's location history does not need to be enabled, and the location of a physical establishment does not need to be known to the system.

By obtaining the unique web analytics identifier from an electronic device of a person at the physical establishment, the physical establishment thereby establishes a link between the person at the physical establishment and the online behaviour associated with the obtained unique web analytics identifier, since both the person and the unique web analytics identifier are associated with the electronic device from which the unique web analytics identifier is obtained. This assumes that the person at the physical establishment is the sole user, or one of the users of the electronic device from which the unique web analytics identifier is obtained.

Information concerning that person's actions at the physical establishment can thereby be combined with the unique web analytics identifier obtained from his/her electronic device. Consequently, information concerning that person's actions at the physical establishment can be combined with his/her online behaviour since the unique web analytics identifier is associated with information concerning that person's online behaviour. In this way, information concerning a person's entire customer journey, i.e. information concerning a person's online actions before entering a physical establishment and his/her online and/or off-line behaviour while he/she is at the physical establishment, can be obtained and analysed.

The unique web analytics identifier is generated by a web analytics company so that it can monitor and record a user's browsing activity including clicking particular buttons, logging in, or recording which pages or advertisements were visited in the past. The unique web analytics identifier may for example be a GCLID, or a combination of a person's browser name and the web analytics company's account number for the company whose website(s) is/are being monitored, or a unique randomly generated string that is stored in a browser's cookie.

The electronic device may be any mobile or non-mobile device that is capable of communicating via a communication network, such as a mobile telephone or smartphone, media player, Personal Communications System (PCS) terminal, Personal Data Assistant (PDA), laptop computer or palmtop receiver or any other hand-held or non-portable, wireless or wired personal communication device (PCD). A communication network may be any collection of terminal nodes, links and any intermediate nodes which are connected so as to enable communication between the terminal nodes, whereby a communication network can include one or more computer networks, the Internet or a telephone network. The communication network is preferably, at least partially, a wireless communication network.

It should be noted that the expressions “data acquiring entity”, “transaction data collection entity” and “data integration entity” as used herein are intended to mean virtual means, such as a website, or non-virtual non-human means, such as a device. It should be noted that these components of the system need not necessarily be separate entities. Any one or more of the components of the system described herein may be combined with one or more other components of the system to constitute one or more arrangements located at one or more locations at one or more physical establishments, or remotely thereto.

According to an embodiment of the invention the data acquiring entity is configured to obtain the unique web analytics identifier from the electronic device of the person when the person is at the physical establishment, i.e. when the person is physically present at the physical establishment, such as inside a building offering goods or services. It should however be noted that the acquiring entity may additionally or alternatively be configured to obtain the unique web analytics identifier from the electronic device of the person before or after he/she has been at the physical establishment, for example if the system allows the person to pay for a service or product, or receive information concerning a service or product before or after he/she has actually been to the physical establishment.

According to an embodiment of the invention the data acquiring entity is configured to obtain the unique web analytics identifier from the electronic device of the person when the person books an appointment to meet somebody at the physical establishment prior to going to the physical establishment or while at the physical establishment, whereby the person uses an electronic device to book the appointment. A person may for example book an appointment online, by telephone, by accessing a URL, by using an electronic device to read a QR code, which may for example be provided by a queue management system associated with one or more physical establishments. It should however be noted that the system according to the present invention is also configured to obtain a unique web analytics identifier from an electronic device of a person who has not booked an appointment prior to going to the physical establishment but who spontaneously turns up at a physical establishment.

For example, according to an embodiment of the invention, the data acquiring entity is configured to obtain the unique web analytics identifier from the electronic device of the person when the person uses the electronic device to obtain an electronic numbered ticket to reserve a place in a queue at a physical establishment. Such an electronic numbered ticket can be obtained by accessing a Uniform Resource Locator (URL). The URL may for example be made available to a person by means of a Quick Response Code displayed at a physical establishment or remotely to a physical establishment, via a website, by means of a beacon transmitting the URL code, or via a text messaging service, such as a Short Message Service (SMS), after entering a mobile phone number when checking in at a physical establishment.

Alternatively or additionally, the data acquiring entity is configured to obtain the unique web analytics identifier from the electronic device of the person when the person uses the electronic device to log into a computer network at the physical establishment, such as to use a physical establishment's Wi-Fi.

According to an embodiment of the invention the data acquiring entity is also configured to obtain data concerning the person's online behaviour from a web analytics company once the unique web analytics identifier has been obtained.

According to an embodiment of the invention the system comprises a presentation device configured to present information related to the person's online behaviour to an employee of the physical establishment.

According to an embodiment of the invention the system comprises transmission means configured to transmit information related to said person's online behaviour, to at least one of the following: the electronic device of said person, one or more parts of the system, or to receiving means located remotely to the system. The system may also comprise data storage means to store information obtained by the system, and/or transmitted to or from the system.

According to an embodiment of the invention the system comprises transmission means configured to transmit the data concerning at least one action performed by the person at the physical establishment to a web analytics company.

According to an embodiment of the invention the data concerning at least one action performed by the person at the physical establishment includes at least one of the following: sales information, service information, arrival time, waiting time, information presented to the person, demonstrations given to the person, employee identification, customer satisfaction information, transaction time, notice of failure to come to a scheduled meeting, information provided by a person when making an appointment.

The present invention also concerns a method performed by a computer-implemented system, namely a computer-implemented system according to any of the embodiments of the invention, to enable data concerning a person's online behaviour to be combined with data concerning at least one action performed by the person at a physical establishment. The method comprises the steps of the system: obtaining a unique web analytics identifier from an electronic device of the person, receiving data concerning at least one action performed by the person at the physical establishment, and combining the person's unique web analytics identifier with the data concerning at least one action performed by the person at the physical establishment, said combining being independent of location data from the electronic device of the person, i.e. location data is not collected from the electronic device of the person.

According to an embodiment of the invention the step of obtaining the unique web analytics identifier from the electronic device of the person is carried out when the person is at the physical establishment.

According to an embodiment of the invention the unique web analytics identifier is obtained from the electronic device of the person when the person uses the electronic device to obtain an electronic numbered ticket to reserve a place in a queue at a physical establishment.

According to an embodiment of the invention the unique web analytics identifier is obtained from the electronic device of the person when the person uses the electronic device to log into a computer network at the physical establishment.

According to an embodiment of the invention the unique web analytics identifier is obtained from the electronic device of the person when the person books an appointment to meet somebody at the physical establishment prior to going to the physical establishment or while at the physical establishment, whereby the person uses an electronic device to book the appointment.

It should be noted that if a person that has booked an appointment at a physical establishment online subsequently cancels his/her appointment or does not turn up for his/her scheduled appointment, this information may be collected and forwarded to a web analytics company.

According to an embodiment of the invention the method comprises the step of obtaining data concerning the person's online behaviour from a web analytics company.

According to an embodiment of the invention the method comprises the step of presenting information related to the person's online behaviour to an employee of the physical establishment.

According to an embodiment of the invention the method comprises the step of transmitting information related to the person's online behaviour to at least one of the following: the electronic device of said person, one or more components of the system, receiving means located remotely to the system.

According to an embodiment of the invention the method comprises the step of transmitting and/or storing the data concerning at least one action performed by the person at the physical establishment to a web analytics company.

According to an embodiment of the invention the data concerning at least one action performed by the person at the physical establishment includes at least one of the following: sales information, service information, arrival time, waiting time, information presented to the person, demonstrations given to the person, employee identification, customer satisfaction information, transaction time, notice of failure to come to a scheduled meeting, information provided by a person when making an appointment.

The present invention also concerns a computer program product that comprises a computer program containing computer program code means arranged to cause a computer or a processor to execute the steps of a method according to any of embodiments of the invention, stored on a computer-readable medium or a carrier wave.

### BRIEF DESCRIPTION OF THE DRAWINGS

The present invention will hereinafter be further explained by means of non-limiting examples with reference to the appended schematic figures where;

FIGS. 1-3 show systems according to embodiments of the invention,

FIG. 4 shows the flow of data through a system according to an embodiment of the invention, and

FIG. 5 is a flow diagram showing the steps of a method according to an embodiment of the invention.

It should be noted that the drawings have not been drawn to scale and that the dimensions of certain features have been exaggerated for the sake of clarity. Any of the features described with reference to an embodiment of the system or method according to the present invention may also be included in any of the other embodiments of the system or method according to the present invention.

### DETAILED DESCRIPTION OF EMBODIMENTS

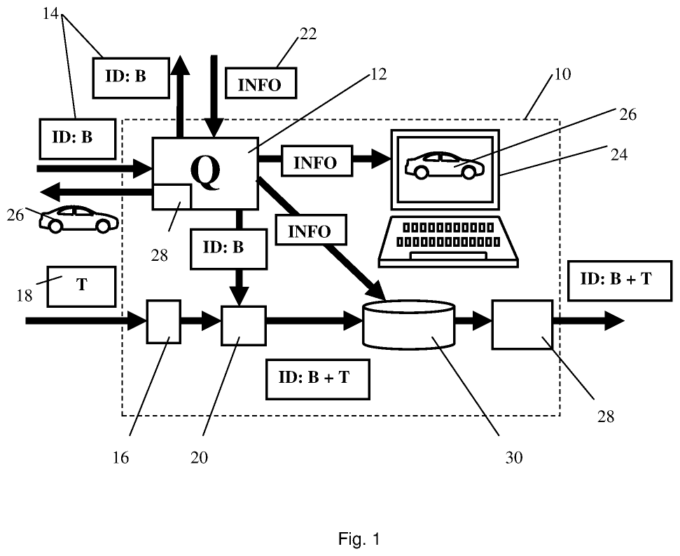

FIG. 1 shows a computer-implemented system 10 configured to enable data concerning a person's online behaviour to be combined with data concerning at least one action performed by the person at a physical establishment according to an embodiment of the invention. The system 10 comprises a data acquiring entity 12 configured to obtain a unique web analytics identifier 14 from an electronic device of the person when he/she is inside a physical establishment for example.

The system 10 also comprises a transaction data collection entity 16 configured to receive data concerning at least one action 18 performed by the person at the physical establishment, which data may be sales data inputted by an employee of the physical establishment or data retrieved from a database, payment system or computer network of the physical establishment.

The system 10 also comprises a data integration entity 20 configured to combine the person's unique web analytics identifier 14 with the data concerning at least one action 18 performed by the person at the physical establishment. The data concerning at least one action 18 performed by the person at the physical establishment includes at least one of the following sales information, service information, arrival time, waiting time, information presented to the person, demonstrations given to the person, employee identification, customer satisfaction information, transaction time, notice of failure to come to a scheduled meeting, information provided by a person when making an appointment.

In the embodiment illustrated in FIG. 1, the data acquiring entity 12 is configured to obtain the unique web analytics identifier 14 from the electronic device of the person when the person uses his/her electronic device to obtain an electronic numbered ticket to reserve a place in queue at the physical establishment. The electronic numbered ticket may be provided by a virtual or non-virtual queue management system associated with the physical establishment, or by the person accessing a URL that is made available when the person uses his/her electronic device to read a QR code associated with the physical establishment, or by the person using his/her electronic device to read a QR code on a paper ticket for example. A queue management system located at a physical establishment, or remotely thereto, may also be arranged to issue paper numbered tickets. Alternatively or additionally, the data acquiring entity 12 may be configured to obtain the unique web analytics identifier 14 from the electronic device of a person when the person books an appointment at the physical establishment prior to coming to the physical establishment or when he/she uses his/her electronic device to log into a computer network at the physical establishment, or in any other suitable way when the person is inside or outside the physical establishment.

The data acquiring entity 12 is also configured to obtain data concerning the person's online behaviour 22 from a web analytics company. According to an embodiment of the invention the system 10 comprises a presentation device 24 and information related to the person's online behaviour 22 may be presented to an employee of the physical establishment. For example, an employee may be provided with information concerning the advertisements, websites and products 26 that the person has been viewing prior to coming to the physical establishment. Alternatively or additionally, the system 10 comprises transmission means 28 configured to transmit information related to the person's online behaviour 22 to the electronic device of said person, for example an advertisement or special offer concerning a product 26 or service that the person has viewed may be sent to the electronic device of the person for example while he/she is at the physical establishment 32.

The transmission means 28 may also be configured to transmit information related to the person's online behaviour 22 to one or more parts of the system 10, such as to a presentation device 24 and/or data storage means 30, and/or to receiving means located remotely to the system 10, such as to a server or database of a web analytics company.

Furthermore, information related to the person's online behaviour 22 need not necessarily only contain information concerning products 26 and services having some connection to the physical establishment 32 that the person is visiting, but may also contain information concerning products and services having no connection to the physical establishment 32 that the person is visiting.

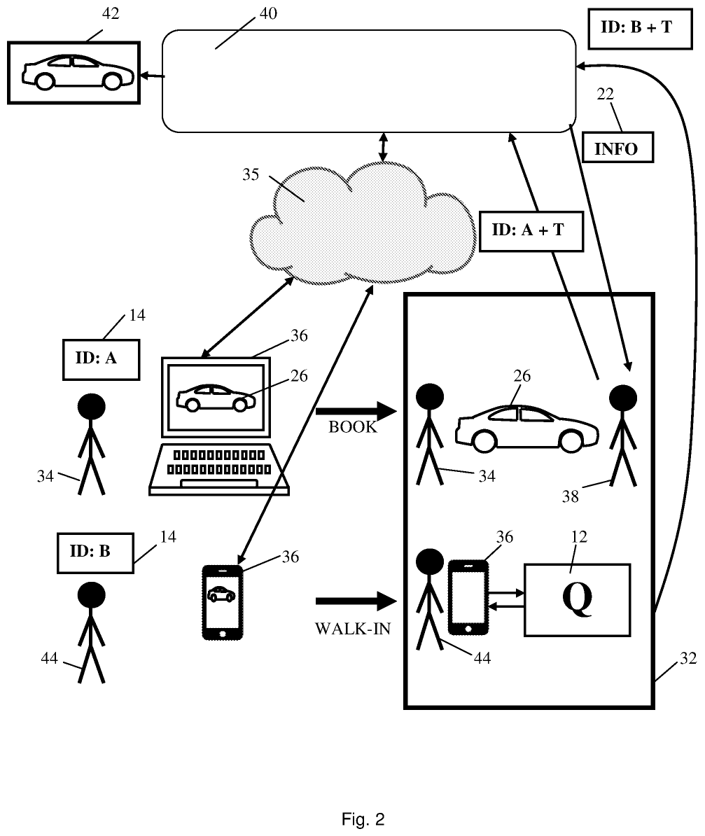

FIG. 2 shows two examples of a method performed by a computer-implemented system to enable data concerning the person's online behaviour to be combined with data concerning at least one action performed by the person at a physical establishment 32.

In the first example, a person 34 who has obtained a unique web analytics identifier 14, ID: A, by viewing a product 26 on a website of a company, such as a car company, books an appointment online to visit a physical establishment 32 selling the products 26 of that company, such as a car showroom, or providing a service, such as the purchase, repair or maintenance of goods.

The unique analytics identifier 14 ID: A, generated by a web analytics company 40, such as Google Analytics, and associated with a particular person 34, is obtained from that person's electronic device 36 via a communication network 35, such as the Internet, in any conventional manner known to the person skilled in the art.

The system 10 has thereby obtained the unique web analytics identifier 14 from an electronic device 36 of the person 34 before the person 34 comes to the physical establishment 32.

The unique web analytics identifier 14 may be used to obtain information concerning the person's online behaviour 22 from a web analytics company 40 before the person 34 arrives for his/her appointment. The employee 38 that is to meet that person 34 may thereby be better prepared for the meeting, and may for example demonstrate and/or sell products 26 and/or provide information of interest to the person 34, such as information concerning medications, healthcare options, financial planning, bank accounts, public services, public transport, tourist activities, sport events, etc.

During or after the meeting, data concerning at least one action 18 performed by the person 34 at the physical establishment 32 may then be inputted into the system 10 by an employee 38 or by the car company's computer network, payment system or database. The person's unique web analytics identifier 14 is thereby combined with the data concerning at least one action 18 performed by the person 34 at the physical establishment 32 and this may be sent to the web analytics company 40. In turn, the web analytics company 40 may then forward information concerning the person's online and offline behaviour to the car company 42 whose website(s) the web analytics company 40 is monitoring.

In this first example, the person 34 does not have to bring an electronic device 36 to the physical establishment 32 in order for the system 10 be able to combine the person's online behaviour with data concerning at least one action 18 performed by that person 34 at the physical establishment 32.

In the second example, a person 44 walks in to a physical establishment 32 carrying an electronic device 32, such as a smartphone, without having made an appointment beforehand. The system 10 associated with the physical establishment 32 is configured to obtained a unique web analytics identifier 14, ID: B, from the electronic device 36 of the person 44 when the person 44 is at the physical establishment 32. The unique web analytics identifier 14, ID: B, may be obtained when the person 44 uses the electronic device 36 to obtain an electronic numbered ticket to reserve a place in a queue at the physical establishment 32 (whereby the electronic numbered ticket issuing means serves as a data acquiring entity 12 of the system 10), and/or when the person 44 uses the electronic device 36 to log into a computer network at the physical establishment 32, or by any other suitable means.

Detailed information, such as the name of the person 34, 44 at the physical establishment 32 does not have to be known to the system 10. The system 10 merely needs to be able to connect a unique web analytics identifier 14 from an electronic device 36 of an anonymous or non-anonymous person 34, 44 with an action performed by that person 34, 44 at the physical establishment 32. The system 10 according to the present invention is not therefore merely a system for monitoring the offline behaviour of registered and/or known users.

a data integration entity (20) configured to combine said person's (34, 44) unique web analytics identifier (14) with said data concerning at least one action (18) performed by said person (34, 44) at said physical establishment (32), said data combining being independent of location data from said electronic device (36) of said person (34, 44).

It should be noted that the electronic device 36 of the person 44 may not itself have been used to view a website being monitored by a web analytics company 40, but it may merely be an electronic device that is associated with another electronic device that has been used to view a website being monitored by a web analytics company 40 and is thereby associated with the same user.

In both of these examples illustrated in FIG. 2, location data from the electronic devices 36 of the people 34, 44 entering the physical establishment 32 is not collected and the location of the physical establishment 32 does not need to be known to the system 10.

The system 10 according to the present invention allows a company 42 whose website(s) is/are being monitored by a web analytics company 40 to compare the number of walk-ins, i.e. people coming to a physical establishment 32 without booking an appointment, with the number of people who booked an appointment before coming to the physical establishment 32.

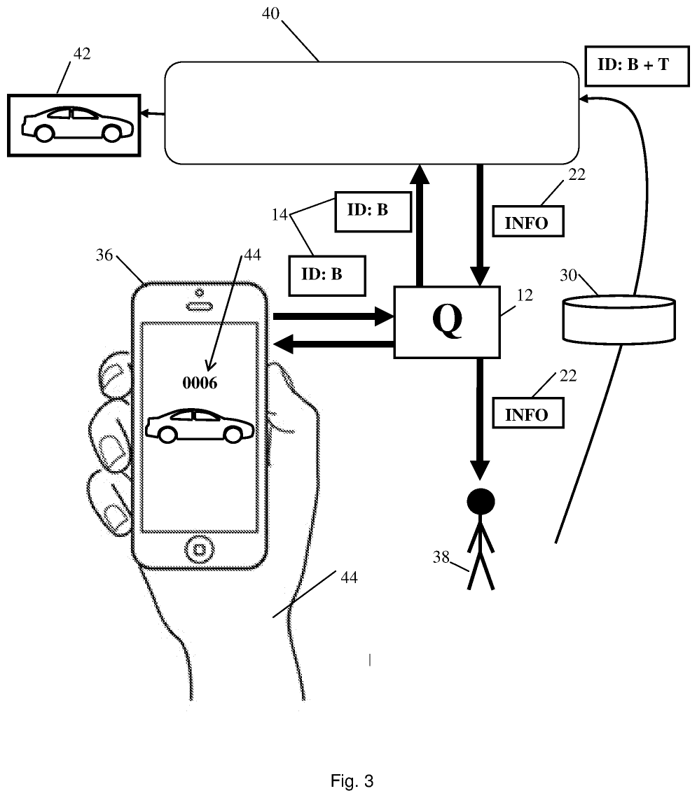

FIG. 3 shows that when a system 10 has obtained the unique web analytics identifier 14, ID: B, of a person 44 entering an establishment and using his/her electronic device 36 to obtain an electronic numbered ticket 44 to reserve a place in a queue at the physical establishment 32, information related to the person's online behaviour 22, such as information and/or promotional material concerning a product 26 that the person 44 has previously viewed, may be transmitted to the person's electronic device 36 while he/she waits for his/her turn to be served.

It should be noted that information related to the person's online behaviour 22 need not necessarily be restricted to information concerning products available at the physical establishment that a person has entered but may relate to anything that the person has previously viewed online.

Information related to the person's online behaviour 22 may also be sent to an employee at the physical establishment prior to or during the meeting with the person 44.

Any or all data concerning at least one action performed by the person 44 at the physical establishment 32, such as sales information, service information, arrival time, waiting time, information presented to the person, demonstrations given to the person, employee identification and/or, customer satisfaction information, information, transaction time, notice of failure to come to a scheduled meeting, information provided by a person when making an appointment, etc. may be stored in the system's data storage means 30 and/or transmitted to a web analytics company 40 and to the company 42 whose website(s) the web analytics company 40 is monitoring. Information that is obtained, stored and/or transmitted by the system 10 may subsequently be used to optimize the person's subsequent online and/or offline experiences.

The present invention concerns a computer program product, such as downloadable application software, that comprises a computer program containing computer program code means arranged to cause one or more computers or processors to execute the steps of a method according to any of the embodiments of the invention. The computer program product is stored on a computer-readable medium or a carrier wave, and may be installed in a computer network or electronic device associated with one or more physical establishments 32.

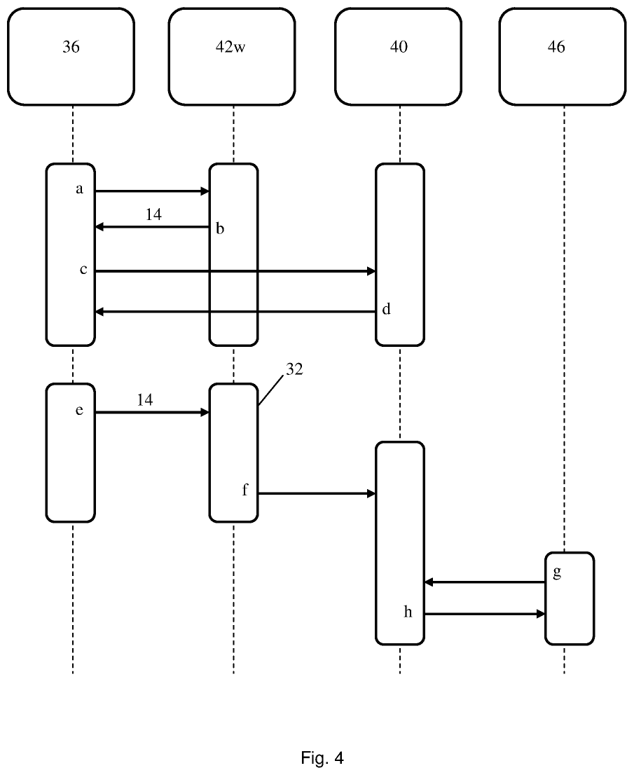

FIG. 4 shows the flow of data through a system according to an embodiment of the invention. In the illustrated embodiment, a person requests a webpage from the website 42w of a company whose website(s) is/are being monitored by a web analytics company 40 (having web analytics scripts enabled) using an electronic device 36 (step a). The webpage including a unique web analytics identifier 14 is returned to the electronic device 36 (step b).

Web analytics script then sends data about the person's online behaviour to the web analytics company 40 (step c). If the person is visiting the website 42w for the first time, the web analytics company 40 returns an identifying tracking cookie which is stored in the web browser of the electronic device 36 (step d). The unique web analytics identifier 14 and/or the identifying tracking cookie may also be sent to one or more other electronic devices associated with the same person.

When that electronic device 36, or another electronic device associated with the same person, is used to interact with a data acquiring entity 12 associated with a physical establishment that is in turn associated with the company whose website(s) is/are being monitored by a web analytics company 40, the unique web analytics identifier 14 will be acquired by the system according to the present invention (step e). The system is configured to collect data concerning at least one action performed by the person at the physical establishment and combine the person's unique web analytics identifier 14 with the data concerning at least one action performed by the person at the physical establishment. This combined data may then be sent to the web analytics company 40 (step f).

A web analyst 46 or computer software may request aggregated data concerning the person's online behaviour and the person's offline behaviour from the web analytics company 40 (step g). All data associated with the person's unique web analytics identifier 14 which has been collected from the user's electronic device 36 by the web analytics company 40 using analytics scripts, as well as all data concerning at least one action performed by the person at the physical establishment which has been associated with that person by acquiring a unique web analytics identifier 14 from an electronic device 36 associated with that person can then be sent to the web analyst 46 of software (step h). The aggregated data may be used for business and market research and/or to assess and improve the effectiveness of a website.

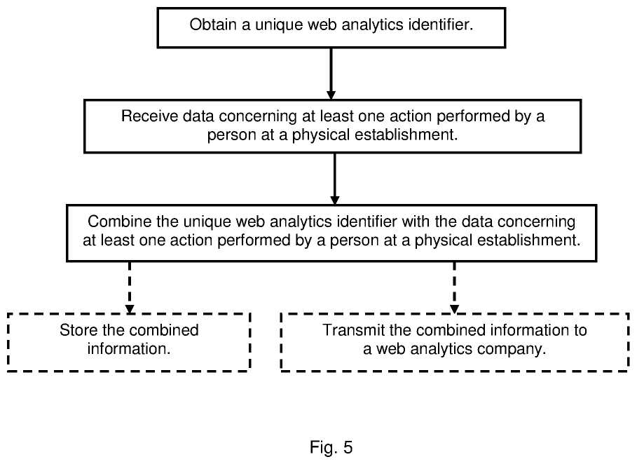

FIG. 5 is a flow diagram showing the steps of a method according to an embodiment of the invention. The method comprises the steps of obtaining a unique analytics identifier from an electronic device of a person, and receiving data concerning at least one action performed by that person at a physical establishment. These two steps may be carried out in any order. The method also comprises the step of combining the person's unique web analytics identifier with data concerning at least one action performed by that person at the physical establishment. This method is conducted entirely without collecting location data from the electronic device of the person or from any other source.

Optionally, the method comprises the steps of storing the combined information and/or the step of transmitting the combined information, for example to a web analytics company.

The method according to an embodiment of the invention may be implemented at any physical establishment providing one or more goods or services.

Further modifications of the invention within the scope of the claims would be apparent to a skilled person.

1. Computer-implemented system configured to enable data concerning a person's online behaviour to be combined with data concerning at least one action performed by said person at a physical establishment, wherein said system comprises:
a data acquiring entity configured to obtain a unique web analytics identifier from an electronic device of said person,
a transaction data collection entity configured to receive data concerning at least one action performed by said person at said physical establishment, and
a data integration entity configured to combine said person's unique web analytics identifier with said data concerning at least one action performed by said person at said physical establishment, said data combining being independent of location data from said electronic device of said person.

2. Computer-implemented system according to claim 1, wherein said data acquiring entity is configured to obtain said unique web analytics identifier from said electronic device of said person when said person is at said physical establishment.

3. Computer-implemented system according to claim 2, wherein said data acquiring entity is configured to obtain said unique web analytics identifier from said electronic device of said person when said person uses said electronic device to obtain an electronic numbered ticket to reserve a place in a queue at said physical establishment.

4. Computer-implemented system according to claim 2, wherein said data acquiring entity is configured to obtain said unique web analytics identifier from said electronic device of said person when said person uses said electronic device to log into a computer network at said physical establishment.

5. Computer-implemented system according to claim 1, wherein said data acquiring entity is configured to obtain said unique web analytics identifier from said electronic device of said person when said person books an appointment at said physical establishment.

6. Computer-implemented system according to claim 1, wherein said data acquiring entity is also configured to obtain data concerning said person's online behaviour from a web analytics company.

7. Computer-implemented system according to claim 6, wherein it comprises a presentation device configured to present information related to said person's online behaviour to an employee of said physical establishment.

8. Computer-implemented system according to claim 6, wherein it comprises data storage means and/or transmission means configured to transmit information related to said person's online behaviour to at least one of the following: said electronic device of said person, one or more components of said system, receiving means located remotely to said system.

9. Computer-implemented system according to claim 1, wherein it comprises transmission means configured to transmit said data concerning at least one action performed by said person at said physical establishment to a web analytics company.

10. Computer-implemented system according to claim 1, wherein said data concerning at least one action performed by said person at said physical establishment includes at least one of the following: sales information, service information, arrival time, waiting time, information presented to said person, demonstrations given to said person, employee identification, customer satisfaction information, transaction time, notice of failure to come to a scheduled meeting, information provided by a person when making an appointment.

11. A method performed by a computer-implemented system to enable data concerning a person's online behaviour to be combined with data concerning at least one action performed by said person at a physical establishment, wherein said method comprises the steps of the system:
obtaining a unique web analytics identifier from an electronic device of said person,
receiving data concerning at least one action performed by said person at said physical establishment, and
combining said person's unique web analytics identifier with said data concerning at least one action performed by said person at said physical establishment, said data combining being independent of location data from said electronic device of said person.

12. Method according to claim 11, wherein said step of obtaining said unique web analytics identifier from said electronic device of said person is carried out when said person is at said physical establishment.

13. Method according to claim 12, wherein said unique web analytics identifier is obtained from said electronic device of said person when said person uses said electronic device to obtain an electronic numbered ticket to reserve a place in a queue at said physical establishment.

14. Method according to claim 12, wherein said unique web analytics identifier is obtained from said electronic device of said person when said person uses said electronic device to log into a computer network at said physical establishment.

15. Method according to claim 11, wherein said unique web analytics identifier is obtained from said electronic device of said person when said person books an appointment at said physical establishment.

16. Method according to claim 11, wherein it comprises the step of obtaining data concerning said person's online behaviour from a web analytics company.

17. Method according to claim 16, wherein it comprises the step of presenting information related to said person's online behaviour to an employee of said physical establishment.

18. Method according to claim 16, wherein it comprises the step of transmitting information related to said person's online behaviour to at least one of the following: said electronic device of said person, to one or more parts of said system, receiving means located remotely to said system.

19. Method according to claim 11, wherein it comprises the step storing said data concerning at least one action performed by said person at said physical establishment and/or transmitting said data concerning at least one action performed by said person at said physical establishment to a web analytics company.

20. Method according to claim 11, wherein said data concerning at least one action performed by said person at said physical establishment includes at least one of the following: sales information, service information, arrival time, waiting time, information presented to said person, demonstrations given to said person, employee identification, customer satisfaction information, transaction time, notice of failure to come to a scheduled meeting, information provided by a person when making an appointment.

21. Computer program product, wherein it comprises a computer program containing computer program code means arranged to cause a computer or a processor to execute the steps of a method according to claim 11, stored on a computer-readable medium or a carrier wave.
